(19) United States
(12) Patent Application Publication
(10) Pub. No.: US 2023/0211689 A1
(43) Pub. Date: Jul. 6, 2023

(54) Electric vehicle battery charging system

(71) Applicant: YEN-HO LU, Taichung (TW)

(72) Inventor: YEN-HO LU, Taichung (TW)

(21) Appl. No.: 17/565,472

(22) Filed: Dec. 30, 2021

(51) Int. Cl. B60L 53/62; B60L 53/68; B60L 53/30; B60L 53/16

(52) U.S. Cl. CPC B60L 53/62; B60L 53/68; B60L 53/305; B60L 53/16

(57) ABSTRACT

An electric vehicle battery charging system, comprising digital map subsystem, operating software that incorporates the digital map subsystem, a plurality of charging units, and a controlling unit that mainly handles booking related matters. The booking flow works as below steps: (a) searching step: to search every possible available charging unit, (b) confirming step: to confirm the electric vehicle arrives at selected charging unit at an acceptable time, (c) charging step: to complete the whole charging session. The system further comprises a preventing measure that prevents the charging units from being occupied unruly and an enhancing measure that enhances charging efficiency out of booking accuracy.

### BACKGROUND OF THE INVENTION

Charging electric vehicles is usually longer than fueling fuel motors in time, and charging may cause a long queue as the growth of electric vehicles is way faster than the buildup of charging stations. Thus making charging efficient would be very important to the development of electric vehicles. The invention employs booking method, as well as featured measures, in an aim to make charging efficient and enhancements in management, maintenance, and business. This system is not just feasible for new-generation charging station, but also for old-model ones that adds on related electrical module to become compatible.

### SUMMARY OF THE INVENTION

An electric vehicle battery charging system, comprising digital map subsystem, operator-side operating software that incorporates the digital map subsystem, a plurality of charging units with each one having its own ID, and a controlling unit that mainly handles booking related matters. The charging workflow of the system works as below steps:

(a) Searching Step: an operator firstly logs into the operating software with an account. Then through the operating software at least info of the operator's location and info of residual battery power (ex. 100 miles or 60 min left before running out of battery power) are provided to the system for analysis to search for every possible available charging unit among the plurality of charging units. The search results are shown on the operating software and comprise at least following info: location marks for the locations of the possible available charging units and info of predicted arrival time (ex. 13:43 pm, or 56 min to arrive) to the locations of the location marks.

In order to help the operator to make better choice, in the search results each of the location marks can be checked in for its detailed info that comprises nearby facility if any. Considering rerouting for the charging happens, the search results can be listed in the order of time of arriving the destination set earlier (if any) on the digital map of the operating software.

(b) Confirming Step: the operator then chooses a selected charging unit, and its ID is located; then at least the ID of the selected charging unit, info of desired time of charging (ex. 14:30 pm or say 40 min after) and info of desired charging duration (ex. 14:30 pm or say 40 min after) are provided to the system to complete an effective booking, which is then recorded in the controlling unit with a given booking id; the controlling unit sends the booking id to the operating software; then a confirming act is needed for validation at the selected charging unit before the booked charging of the effective booking is considered valid.

(c) Charging Step: upon completion of the confirming act in previous step and detection of successful connection between the electric vehicle to be charged and the selected charging unit, the system then grants for activating the charging session in association to the effective booking. When the charging session is finished, the system would automatically terminate the charging power. To remind the operator, the system would send notification to the operator regarding to the completion of the charging session.

Moreover, in order to make the whole system well rounded, the system comprises an enhancing measure that enhances charging efficiency out of booking accuracy and a preventing measure that prevents the charging units from being occupied unruly. Furthermore, the system can also provide enhancements in business, management and maintenance aspects.

### DETAILED DESCRIPTION OF THE INVENTION

Please refer to an embodiment for the invention as below. An electric vehicle battery charging system, comprising digital map subsystem, operator-side operating software that incorporates the digital map subsystem, a plurality of charging units with each one having its own ID, and a controlling unit that mainly handles booking related matters and comprises data of each of the charging units that comprises its ID, property info, and location info (ex. info of latitude and longitude, or simply a code). The location info can be recognized by the digital map subsystem so to show its actual geographical location on the digital map of the operating software. The communications among the controlling unit, the charging units, and the operating system are conducted wirelessly. The operating system could be an app operated on the mobile phone for example.

The charging workflow of the system works as below steps: (the illustration for the technology of the digital map subsystem would be omitted below because the way it works, for example: Google Map, is known.)

(a) Searching Step 10: an operator firstly logs into the operating software with an account, and the operator's location is detected by the digital map subsystem. Through the operating software, info of the operator's location and info of residual battery power of the electric vehicle to be charged are provided to the system for analysis to search, among the plurality of charging units, for every possible available charging unit (hereafter called PACU), which may comprise conditional ones, for example, lodging business usually offers charging services to its customers only. The PACU mainly comprises the ones that the electric vehicle to be charged can arrive given the residual battery power and that could be available (ex. no time conflicts with established bookings of others and with in-process onsite charging) for charging at the time the electric vehicle to be charged arrives. The search results are shown on the operating software and comprise following info: location marks for the locations of the PACU and info of predicted arrival time to the locations of the location marks. The searching results would show just one location mark for a plural number of the PACU that are located very close and belong to the same property or managing entity (ex. a hotel owns multiple charging units located in its parking lot). And the location mark for a plural number of the PACU comes with a number sign on it to indicate the number of the PACU involved. Each of the location marks can be checked in for its detailed info that not just comprises info of the charging units involved, but also info of nearby facility if any (ex. restaurant, toilet, supermarket, lodging and etc.) and property info of the PACU.

The property info comprises the info of charging plug type and charging power. To narrow down, the search results can be filtered by at least one of the followings: nearby facility, charging plug type, and charging power. Provided that a final destination is set earlier on the digital map of the operating software, the search results also can be sorted and listed in the order of time of arriving the destination for rerouting for the charging.

(b) Confirming Step 20: the operator checks around the PACU shown on the digital map of the operating system, chooses a selected charging unit among all the PACU, and then its ID is automatically located by the system. Through the operating software, the operator provides at least the ID of the selected charging unit, info of desired time of charging and info of desired charging duration to the controlling unit to complete an effective booking, which is then recorded in the controlling unit with a given booking id. The controlling unit then sends the booking id to the operating software. For the effective booking, a confirming act is needed for validation at the selected charging unit before the booked charging of the effective booking is considered valid.

The confirming act can be implemented by at least one of following methods: (a) given the ID of the selected charging unit (ex. can be a serial number or QR code) is shown on its exterior. When arriving at the selected charging unit, the operator provides the ID (ex. scan the QR code if it is the format) and the booking id to the controlling unit via the operating software. With the booking id, the controlling unit then locates the associated effective booking recorded within and further find the ID of the selected charging unit. The controlling unit at last validates the received ID with the found ID and also validate if the time at the moment of validation falls within a set time window (ex. between 5 min before and 10 min after the desired time of charging of the associated effective booking) to complete the confirming act, and (b) the effective booking further comprises plate number info (ex. a plate number info needs to be provided when establishing a booking), and the plate number info is also recorded and linked to the effective booking in the controlling unit. Moreover, the selected charging unit further comprises a camera. When the electric vehicle to be charged arrives at the selected charging unit, the camera would automatically takes shot of its plate number, and the selected charging unit then automatically sends its own ID and the shot image to the controlling unit for processing. Through image recognition processing the controlling unit obtains a recognized plate number. The controlling unit then uses the recognized plate number and the received ID for validation (ex. the controlling unit uses the received ID to locate the associated effective booking recorded within and further validate the recognized plate number with the plate number info linked to the associated effective booking) and also validate if the time at the moment of validation falls within a set time window around the desired time of charging of the associated effective booking to complete the confirming act.

(c) Charging Step 30: upon completion of the confirming act in previous step and detection of successful connection between the electric vehicle to be charged and the selected charging unit (ex. via charging plug), the system then grants for activating the in association to the effective booking. By pressing the “activating” button on the selected charging unit, the charging session starts. When the charging session is finished, the system would automatically terminate charging power, and sends notification to the operator (ex. to the operating system 5 min before the completion of the charging session) to request to move the electric vehicle away within a set time duration after ending time of charging.

More, the system comprises a preventing measure that prevents the charging units from being occupied unruly. The measure can be implemented by at least one of following methods: (a) at a set time after the charging session is finished, the system would perform an act (ex. giving the associated account extra penalty charge plus a bad record) upon detection that the selected charging unit and the electric vehicle are still connected (i.e. charging plug is still plugged in the vehicle, meaning the vehicle does not leave yet); (b) given a plural number of the plurality of charging units further comprise cameras. When a camera-equipped charging units is not in charging session, its camera would periodically takes images, which would automatically be sent to the controlling unit for processing image recognition to detect plate number. If the system keeps detecting same plate number for a set time duration (ex. over 20 min) from the camera-equipped charging unit not in charging session, then the system would perform an act (ex. sending related data to the authority for a penalty).

Moreover, the system comprises an efficiency-enhancing measure that enhances charging efficiency out of booking accuracy as follows: (a) when the effective booking is not canceled by the operator and the confirming act is not completed after a set time, the system would perform an act (ex. give the account a demerit). If in the account the situation accumulates over a set condition (ex. over 3 demerits in a month), the system would perform another act, such as suspending booking services for the account, and (b) when the system detects that actual charging session is shorter than the desired charging duration for the effective booking and over a set condition (ex. actual charging session is over 20 min shorter due to manual stopping for example), the system would perform an act (ex. give the account a demerit). If in the account the situation accumulates over a set condition (ex. over 3 demerits in a month), the system would perform another act, such as suspending booking services for the account.

Furthermore, the system provides enhancements in business, management and maintenance as illustrated as below: (a) given the system further comprising managing software, enabling a man remotely command the controlling unit to change charging rate of charging units through the controlling software. And further, the controlling unit comprises artificial intelligence computation technology (ex. based on weather, holiday, searching popularity and etc.), and it can automatically and dynamically control charging rate in the system to enhance profitability; (b) the operation software comprises a trouble-reporting function for unable to fulfill the effective booking with unexpected troubles at the selected charging unit. For the charging units set in rural area or no man-service condition, the breakage of a charging unit can be quickly known by the system. This is because operators' reporting through the operating software can be expected if their selected charging units are broken, otherwise they may get charged or penalized for not exercising bookings of theirs; (c) moreover, another feature is that the operating software further comprises a payment platform for the charging session, and it can be entered a discount code info. It is helpful in encouraging consumption to get the discount code, benefitting the owner of the charging units who is a shopping mall; (d) further, the detailed info of the searching results further comprises advertisements (if any, ex. an nearby restaurant pertaining to a possible available charging unit offers a discount) to embrace another income source; (e) furthermore of a way of profiting is that the system can even charge a fee for the booking itself. Another merit of doing this is that it may effectively prevent people from casual booking behaviors, which bring hassles to those who really need the booking service.

### BRIEF DESCRIPTION OF THE INVENTION

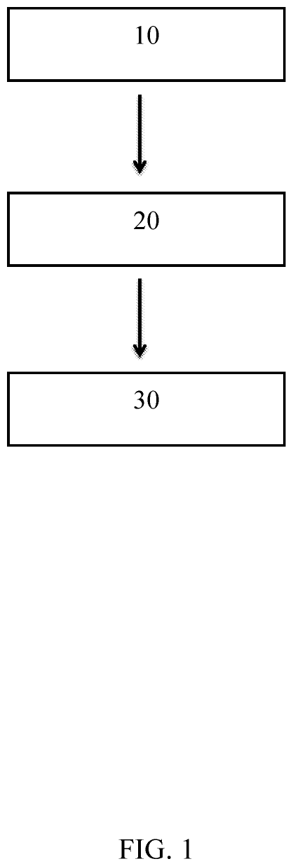

FIG. 1: the charging workflow of the system

1. An electric vehicle battery charging system, comprising digital map subsystem, operator-side operating software that incorporates the digital map subsystem, a plurality of charging units with each one having its own ID, and a controlling unit that mainly handles booking related matters; the charging workflow of the system works as below steps:
(a) Searching Step: an operator firstly logs into the operating software with an account; then through the operating software at least info of the operator's location and info of residual battery power are provided to the system for analysis to search for every possible available charging unit among the plurality of charging units; the search results are shown on the operating software and comprise at least following info: location marks for the locations of the possible available charging units and info of predicted arrival time to the locations of the location marks;
(b) Confirming Step: the operator chooses a selected charging unit, and its ID is located by the system; then at least the ID of the selected charging unit, info of desired time of charging and info of desired charging duration are provided to the system to complete an effective booking, which is then recorded in the controlling unit with a given booking id; the controlling unit sends the booking id to the operating software; then a confirming act is needed for validation at the selected charging unit before the booked charging of the effective booking is considered valid;
(c) Charging Step: upon completion of the confirming act and detection of successful connection between the electric vehicle to be charged and the selected charging unit, the system grants for activating the charging session in association to the effective booking.

2. An electric vehicle battery charging system as claim 1, wherein the confirming act can be implemented by at least one of following methods: (a) the ID of the selected charging unit is shown on its exterior; when arriving at the selected charging unit, the operator provides the ID and the booking id to the controlling unit via the operating software; with the booking id, the controlling unit then locates the associated effective booking recorded within and further finds the ID of the selected charging unit; the controlling unit validates the received ID with the found 1D and also validate if the time at the moment of validation falls within a set time window; (b) the effective booking further comprises plate number info; the selected charging unit further comprises a camera; when the electric vehicle to be charged arrives at the selected charging unit, the camera would automatically take shot of its plate number, and the selected charging unit then automatically sends its ID and the shot image to the controlling unit; through processing the controlling unit obtains a recognized plate number; the controlling unit then uses the recognized plate number and the received ID for validation and also validate if the time at the moment of validation falls within a set time window.

3. An electric vehicle battery charging system as claim 1, wherein each of the location marks can be checked in for its detailed info, which comprises info of nearby facility if any.

4. An electric vehicle battery charging system as claim 1, wherein the search results can be listed in the order of time of arriving the destination set earlier on the digital map of the operating software.

5. An electric vehicle battery charging system as claim 1, wherein the system comprises at least one of following measures for enhancement: (a) a preventing measure that prevents the charging units from occupied unruly; (b) an efficiency-enhancing measure that is to enhance charging efficiency out of booking accuracy.

6. An electric vehicle battery charging system as claim 5, wherein the preventing measure is implemented by at least one of following methods: (a) at a set time after the charging session is finished, the system would perform an act upon detection that the selected charging unit and the electric vehicle are still connected; (b) given a plural number of the plurality of charging units further comprise cameras; when a camera-equipped charging units is not in charging session, its camera would periodically takes images, which would automatically be sent to the controlling unit tor processing to detect plate number; if the system keeps detecting same plate number for a set time duration from the camera-equipped charging unit not in charging session, then the system would perform an act.

7. An electric vehicle battery charging system as claim 5, wherein the efficiency-enhancing measure is implemented by at least one of following methods: (a) when the effective booking is not canceled and the confirming act is not completed after a set time, the system would perform an act; (b) when the system detects that actual charging session is shorter than the desired charging duration for the effective booking and over a set condition, the system would perform an act.

8. An electric vehicle battery charging system as claim 1, wherein charging rate of the charging units can be managed by at least one of following methods: (a) the charging rate can be changed remotely by man through the controlling unit; (b) the charging rate can be automatically and dynamically changed by the controlling unit.

9. An electric vehicle battery charging system as claim 1, wherein the operating software further comprises a payment platform for the charging session, and it can be entered a discount code info.

10. An electric vehicle battery charging system as claim 3, wherein the detailed info further comprises advertisements.

11. An electric vehicle battery charging system as claim 1, wherein the operating software comprises a trouble-reporting function for unable to fulfill the effective booking with unexpected troubles.

12. An electric vehicle battery charging system as claim 1, wherein the location mark for a plural number of the possible available charging units comes with a number sign on it to indicate the number of the possible available charging units involved.

13. An electric vehicle battery charging system as claim 3, wherein the search results further comprises info of charging plug type and charging power type of the possible available charging units and thus can be filtered by at least one of the followings: (a) the nearby facility, (b) the charging plug type, and (c) the charging power type.

14. An electric vehicle battery charging system as claim 1, wherein the search results further comprises info, charging plug type and charging power type of the possible available charging units and thus can be filtered by at least one of the followings: (a) the charging plug type, and (b) the charging power type.

15. An electric vehicle battery charging system as claim 1, wherein the searching results would show just one location mark for a plural number of the possible available charging units that are located very close and belong to the same managing entity.

16. An electric vehicle battery charging system as claim 1, wherein when the charging session is finished, the system would automatically terminate charging power.

17. An electric vehicle battery charging system as claim 1, wherein the system charges a fee for the booking itself.
